(19) United States
(12) Patent Application Publication
(10) Pub. No.: US 2024/0283896 A1
(43) Pub. Date: Aug. 22, 2024

(54) COMMUNICATION APPARATUS, COMMUNICATION SYSTEM, COMMUNICATION METHOD, AND STORAGE MEDIUM

(71) Applicant: CANON KABUSHIKI KAISHA, Tokyo (JP)

(72) Inventor: MITSUMASA ABE, Kanagawa (JP)

(21) Appl. No.: 18/444,391

(22) Filed: Feb. 16, 2024

(30) Foreign Application Priority Data
Feb. 22, 2023 (JP) 2023-026412

(51) Int. Cl. H04N 7/18; H04N 1/00

(52) U.S. Cl. CPC H04N 7/181; H04N 1/00095

(57) ABSTRACT

A communication apparatus includes a reception unit configured to receive a first image packet, a generation unit configured to generate a second image packet, a transmission unit configured to, in a case where predetermined information is included in the first image packet, transmit the first image packet from which the predetermined information is deleted and the second image packet including the predetermined information, and a control unit configured to, in a case where the second image packet cannot be generated, cause the transmission unit to transmit a communication packet including at least the predetermined information.

### BACKGROUND

### Field of the Disclosure

The present disclosure relates to a communication apparatus, a communication system, a communication method, and a storage medium.

### Description of the Related Art

In recent years, a system has been discussed where a plurality of cameras captures an object from a plurality of directions.

For example, Japanese Patent Application Laid-Open No. 2021-93661 discusses a system where, based on images captured by a plurality of cameras that captures an object from a plurality of directions, a virtual viewpoint image of the object is generated. In this system, a plurality of camera adapters is connected to each other in a daisy chain. Then, pieces of image data created by the camera adapters are sequentially transmitted as image packets between the camera adapters, and the pieces of image data of all the camera adapters are ultimately transmitted to a front-end server.

However, for example, in a case where a camera failure occurs in an apparatus in the middle of a daisy chain connection and the apparatus cannot generate image data, not only an image packet of the apparatus that cannot generate the image data, but also image packets of image data generated by apparatuses downstream of the apparatus are not transmitted.

### SUMMARY

The present disclosure is directed to, even in a case where an upstream apparatus cannot generate image data, enabling transmission of an image packet of image data generated by a downstream apparatus.

According to an aspect of the present disclosure, a communication apparatus includes a reception unit configured to receive a first image packet, a generation unit configured to generate a second image packet, a transmission unit configured to, in a case where predetermined information is included in the first image packet, transmit the first image packet from which the predetermined information is deleted and the second image packet including the predetermined information, and a control unit configured to, in a case where the second image packet cannot be generated, cause the transmission unit to transmit a communication packet including at least the predetermined information.

Further features of the present disclosure will become apparent from the following description of exemplary embodiments with reference to the attached drawings.

### BRIEF DESCRIPTION OF THE DRAWINGS

FIG. 1 is a system configuration diagram of a synchronous imaging system according to one or more aspects of the present disclosure.

FIG. 2 is a diagram illustrating an example of transmission of image packets in the synchronous imaging system.

FIG. 3 is a diagram illustrating an issue in a comparative example.

FIG. 4 is a diagram illustrating an internal configuration of a camera adapter according to one or more aspects of the present disclosure.

FIG. 5 is a functional block diagram illustrating internal functions of a transmission unit according to one or more aspects of the present disclosure.

FIG. 6 is a diagram illustrating an internal configuration of an image packet.

FIG. 7 is a flowchart illustrating operations of transmitting and the like an image packet performed by the transmission unit.

FIG. 8 is a flowchart illustrating a process of setting an abnormality flag.

FIG. 9 is a flowchart illustrating operations of transmitting and the like an image packet according to one or more aspects of the present disclosure.

FIG. 10 is a functional block diagram illustrating internal functions of a transmission unit according to one or more aspects of the present disclosure.

FIG. 11 is a flowchart illustrating a process of setting an abnormality flag according to one or more aspects of the present disclosure.

### DESCRIPTION OF THE EMBODIMENTS

With reference to the attached drawings, exemplary embodiments of the present disclosure will be described in detail below. The following exemplary embodiments do not limit the present disclosure, and not all the combinations of the features described in the exemplary embodiments are essential for a method for solving the issues in the present disclosure. The configurations of the exemplary embodiments can be appropriately modified or changed depending on the specifications of a system and an apparatus to which the present disclosure is applied, or various conditions (the use conditions and the use environment). The technical scope of the present disclosure is determined by the appended claims, and is not determined by the following individual exemplary embodiments.

In the following description, a component illustrated in a drawing previously referenced is appropriately described with reference to another drawing that follows.

### <Configuration of Synchronous Imaging System>

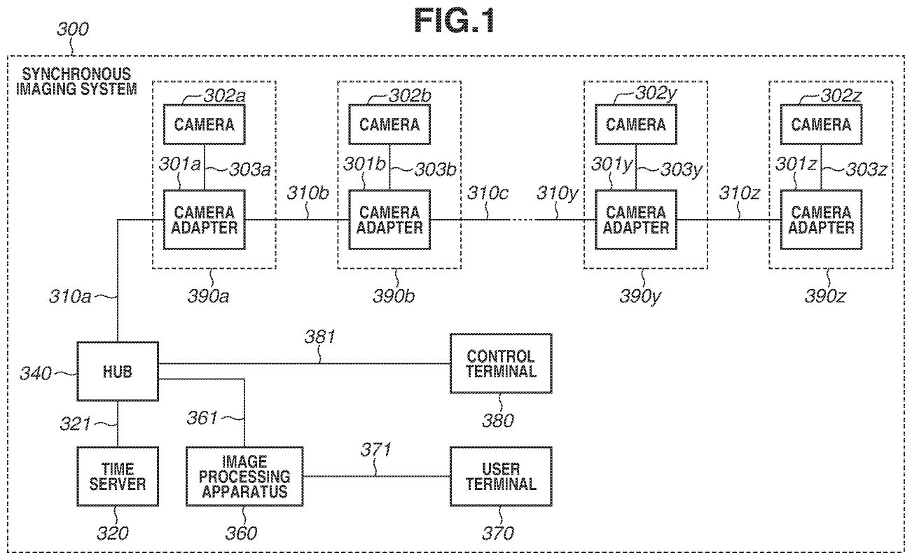

FIG. 1 is a system configuration diagram of a synchronous imaging system according to a first exemplary embodiment.

A synchronous imaging system 300 is a system where a plurality of cameras is installed in a facility, such as a sports field (a stadium) or a concert hall, and captures images. The synchronous imaging system 300 includes imaging units 390a to 390z, a time server 320, an image processing apparatus 360, a user terminal 370, a control terminal 380, and a hub 340. A network is formed of these components of the synchronous imaging system 300, and the hub 340 has the function of routing a communication packet.

In the following description, components of the same type distinguished by alphabetical letters suffixed to the reference signs may be occasionally collectively termed using reference signs obtained by omitting the suffixes. For example, the 26 imaging units 390a to 390z will be occasionally collectively referred to as “the imaging units 390”.

The control terminal 380 manages operation states of the components of the synchronous imaging system 300 and controls the settings of parameters of the components via the network. The network may be Ethernet® such as Gigabit Ethernet (GbE), 10GbE, or 100GbE compliant with an Institute of Electrical and Electronics Engineers (IEEE) standard. Alternatively, the network may be constructed by combining InfiniBand that is an interconnect, industrial Ethernet, and the like. Yet alternatively, the network may not be limited to these, and may be a network of another type.

Each imaging unit 390 includes a camera 302 and a camera adapter 301. Images captured by cameras 302 are input to the image processing apparatus 360 via the network. The image processing apparatus 360 processes the input images, thereby generating a virtual viewpoint image. The user terminal 370 is operated by a user, specifies a viewpoint in the image processing apparatus 360, and displays the virtual viewpoint image on a display screen.

While the synchronous imaging system 300 includes the 26 imaging units 390a to 390z as an example, the number of imaging units 390 is not limited to this. Further, the plurality of imaging units 390 may not have the same configuration, and for example, each of the imaging units 390 may be configured to include an apparatus of a different model. The present exemplary embodiment is described on an assumption that the term “image” includes concepts of a moving image and a still image, unless otherwise stated. In other words, the synchronous imaging system 300 according to the present exemplary embodiment can process both a still image and a moving image.

The imaging units 390a to 390z included in the synchronous imaging system 300 are connected to each other in a daisy chain using a first network cable 310a to a twenty-sixth network cable 310z.

In the network where the plurality of imaging units 390a to 390z is connected to each other, a side close to the hub 340 is referred to as a “root side”, and a side far from the hub 340 is referred to as a “leaf side”. In transmission of a communication packet in the synchronous imaging system 300, the root side may be upstream, or the leaf side may be upstream. Similarly, in each imaging unit 390 or each camera adapter 301, a side close to the hub 340 is referred to as the “root side”, and a side far from the hub 340 is referred to as the “leaf side”.

FIG. 1 illustrates a configuration in which all the 26 imaging units 390a to 390z are connected to each other in a daisy chain. The connection form in the synchronous imaging system 300, however, is not limited to this. For example, the plurality of imaging units 390 may be divided into several groups, and imaging units 390 may be connected to each other in a daisy chain in each divided group.

Such a configuration is particularly effective in a stadium. For example, a case is possible where the stadium includes a plurality of floors, and a daisy chain of the imaging units 390 is provided on each floor. In this case, inputs can be provided to the image processing apparatus 360 with respect to each floor or each half circumference of the stadium. Thus, even in a place where it is difficult to install wiring for connecting all the imaging units 390 in a single daisy chain, the installation is simplified, and the system is made flexible.

As described above, each imaging unit 390 includes the camera 302 and the camera adapter 301. In other words, the synchronous imaging system 300 includes a plurality of (e.g., 26) cameras 302 for capturing an object from a plurality of directions. The plurality of cameras 302 included in the synchronous imaging system 300 may be different in performance or model from each other.

Each imaging unit 390 is not limited to the configuration in which the imaging unit 390 includes the camera 302 and the camera adapter 301. Alternatively, for example, each imaging unit 390 may include an audio device, such as a microphone, or a pan head for controlling a direction of the camera 302. Yet alternatively, for example, the imaging unit 390 may include a single camera adapter 301 and a plurality of cameras 302, or may include a single camera 302 and a plurality of camera adapters 301. In other words, the plurality of cameras 302 and the plurality of camera adapters 301 in the synchronous imaging system 300 are in correspondence of N-to-M (N and M are integers greater than or equal to 1).

While FIG. 1 illustrates only a single connection 303 between the camera 302 and the camera adapter 301, the number of connections 303 is not limited to one. A plurality of connections 303, such as a signal line for controlling the camera 302 and a signal line for transmitting data captured by the camera 302, may be provided.

Alternatively, the camera 302 and the camera adapter 301 may be integrally formed. Further, the image processing apparatus 360 may have at least some of the functions of the camera adapter 301. The following description is given using, as an example, a case where each imaging unit 390 includes a single camera 302 and a single camera adapter 301 of the same types.

### <Generation of Virtual Viewpoint Image>

The camera adapter 301 of each imaging unit 390 transmits an image obtained through image capturing by the camera 302 in a format of an image packet to which image data is attached to the image processing apparatus 360 via the daisy chain connection. With the connection form in which the imaging units 390 are connected to each other in the daisy chain, it is possible to reduce the number of connection cables and save labor in wiring work in dealing with an increased volume of image data resulting from an increased resolution of a captured image to 4K or 8K and an increased frame rate of a captured image.

Control of image processing by the image processing apparatus 360 can be switched depending on whether a single camera adapter 301 or a plurality of camera adapters 301 is located at one end of the daisy chain connection on the image processing apparatus 360 side. More specifically, the control by the image processing apparatus 360 can be switched depending on whether the imaging units 390 are divided into a plurality of groups.

A camera adapter 301 located at one end of the daisy chain connection on the image processing apparatus 360 side relays an image from a camera adapter 301 of another imaging unit 390 connected in the daisy chain and inputs the image to the image processing apparatus 360.

In a case where there is a single camera adapter 301 that inputs an image, images of the entire circumference of the sports field are generated while the images are transmitted through the daisy chain connection, and thus, timings when all the images of the entire circumference are obtained by the image processing apparatus 360 are synchronized with each other. In other words, the timings can be synchronized with each other if the imaging units 390 are not divided into groups.

However, in a case where there is a plurality of camera adapters 301 that inputs images, it is possible that a delay from capturing of an image to inputting of the image to the image processing apparatus 360 differs with respect to each lane (path) of the daisy chain. In other words, in a case where the imaging units 390 are divided into groups, the timings when images for the entire circumference are input to the image processing apparatus 360 may not be synchronized with each other. Thus, the image processing apparatus 360 needs to perform image processing while checking the collection of the images by synchronization control that waits until all pieces of image data for the entire circumference are obtained and then synchronizes timings.

In each lane of the daisy chain, for example, an image captured by a camera 302z of the twenty-sixth imaging unit 390z is subjected to image processing and then packetized by a camera adapter 301z. The image packetized by the twenty-sixth imaging unit 390z is transmitted to a camera adapter 301y of the twenty-fifth imaging unit 390y via the network cable 310z of the daisy chain. The packetized image is transmitted as an image packet.

The twenty-fifth imaging unit 390y transfers the image packet received from the twenty-sixth imaging unit 390z to the twenty-fourth imaging unit 390x downstream of the twenty-fifth imaging unit 390y. Further, the twenty-fifth imaging unit 390y performs image processing on an image captured by a camera 302y, then packetizes the image, and transmits the packetized image to the twenty-fourth imaging unit 390x.

The above operation is executed by each imaging unit 390, whereby an image packet of an image acquired by the imaging unit 390 is transmitted from the first imaging unit 390a to the hub 340 and then transmitted to the image processing apparatus 360.

The image processing apparatus 360 processes the image captured by and transmitted from each imaging unit 390. First, the image processing apparatus 360 reconstructs an image based on the transmitted image packet. The image is reconstructed using a camera adapter identifier (ID), an image type, and a frame number included in header information regarding the image packet. The image processing apparatus 360 stores the image in association with these pieces of information.

The image processing apparatus 360 receives a specification of a viewpoint from the user terminal 370, reads corresponding images from stored information based on the specified viewpoint, and performs a rendering process on the corresponding images, thereby generating a virtual viewpoint image. The control terminal 380, the imaging units 390, or the user terminal 370 may have at least some of the functions of the image processing apparatus 360.

The virtual viewpoint image generated by the rendering process is transmitted from the image processing apparatus 360 to the user terminal 370 and displayed on the display screen of the user terminal 370. The user operating the user terminal 370 can view an image from a viewpoint according to the specification.

More specifically, the image processing apparatus 360 generates a virtual viewpoint content based on captured images (a plurality of viewpoint images) captured by the plurality of cameras 302 and viewpoint information.

While the virtual viewpoint content is generated by the image processing apparatus 360 in the present exemplary embodiment, the virtual viewpoint content may be generated by the control terminal 380 or the user terminal 370.

### <Synchronization of Time>

The time server 320 has a function of distributing time. More specifically, the time server 320 distributes time to the imaging units 390 using synchronization packets that are communication packets for synchronizing time between the imaging units 390. The camera adapters 301 transmit and receive the synchronization packets through the daisy chain. The camera adapters 301 genlock the cameras 302 based on time information included in the synchronization packets and synchronize image frames between the cameras 302.

Each camera adapter 301 has the transparent clock function and the ordinary clock function in the Precision Time Protocol (PTP). More specifically, when the camera adapter 301 transfers a received synchronization packet, the camera adapter 301 calculates a residence time in the imaging unit 390 and adds the residence time to the synchronization packet. Then, the camera adapter 301 transfers the synchronization packet to the subsequent camera adapter 301, and the camera adapter 301 is synchronized with the time of the time server 320 based on the received synchronization packet.

All the camera adapters 301 in the synchronous imaging system 300 have the above-described two functions and thereby can synchronize time with the time server 320 with high precision. Then, the plurality of camera adapters 301 having synchronized their times with each other based on the time server 320 can synchronize imaging timings of the cameras 302 with each other. The hub 340 has the transparent clock function in the PTP.

If a failure occurs in the time server 320, the synchronous imaging system 300 breaks down. Thus, redundancy may be achieved by placing a plurality of time servers 320. If redundancy is achieved, the time servers 320 are synchronized with each other using the Global Positioning System (GPS) or the like, so that times are synchronized between the time servers 320.

### <Transmission of Image Packet>

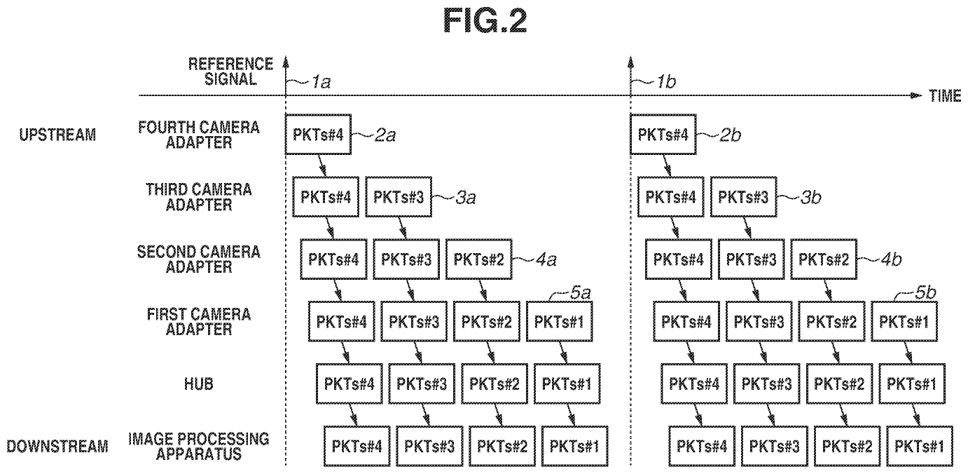

FIG. 2 is a diagram illustrating an example of the transmission of image packets in the synchronous imaging system 300.

For convenience of description, however, a case is illustrated where the synchronous imaging system 300 includes four camera adapters 301.

All the camera adapters 301 have the times synchronized with each other based on the PTP, and images are captured in synchronization with reference signals 1a and 1b at the same timings generated in the camera adapters 301.

Image packets 2a to 5a and 2b to 5b of foreground images obtained by clipping object portions, such as human bodies, from images obtained by image capturing are transmitted in order from the fourth camera adapter 301 that is the furthest upstream to the image processing apparatus 360 with the reference signals 1a and 1b as starting points. While each of the image packets 2a to 5a and 2b to 5b is illustrated as a single block in FIG. 2, each of the actual image packets 2a to 5a and 2b to 5b is a packet group composed of one or more image packets. More specifically, each camera adapter 301 divides a captured image where necessary, attaches divided captured images to a packet group, and continuously transmits the packets until transmission of all pieces of image data is completed.

The third camera adapter 301 transmits (transfers) the image packets 2a and 2b received from the fourth camera adapter 301 adjacent to and upstream of the third camera adapter 301 to the second camera adapter 301 adjacent to and downstream of the third camera adapter 301. Using start instruction information included in the image packets 2a and 2b, which are received from the fourth camera adapter 301 adjacent to and upstream of the third camera adapter 301, as a trigger, the third camera adapter 301 starts generating and transmitting the image packets 3a and 3b of the third camera adapter 301.

Similarly, the second camera adapter 301 transmits the image packets 2a, 2b, 3a, and 3b of the fourth and third camera adapters 301, which are transmitted from the third camera adapter 301, downstream. Using start instruction information included in the image packets 3a and 3b generated by the third camera adapter 301 as a trigger, the second camera adapter 301 starts generating and transmitting the image packets 4a and 4b.

The first camera adapter 301 transmits the image packets 2a, 2b, 3a, 3b, 4a, and 4b of the fourth, third, and second camera adapters 301 downstream. Then, using start instruction information included in the image packets 4a and 4b, which are generated by the second camera adapter 301, as a trigger, the first camera adapter 301 starts generating and transmitting the image packets 5a and 5b.

In other words, each camera adapter 301 receives the image packets of all the camera adapters 301 upstream of the camera adapter 301, transfers the image packets, and using the start instruction information included in the image packets of the camera adapter 301 adjacent to and upstream of the camera adapter 301 as a trigger, starts generating and transmitting image packets. As a result, all the image packets 2a to 5a and 2b to 5b are transmitted to the image processing apparatus 360 via the hub 340.

For convenience, FIG. 2 illustrates a case where the fourth camera adapter 301 starts generating and transmitting the image packets 2a and 2b at the timings of the reference signals 1a and 1b.

Actually, however, image processing latency and imaging latency of the camera occur in the camera adapter 301. Thus, the image packets 2a and 2b are transmitted at timings after those of the reference signals 1a and 1b.

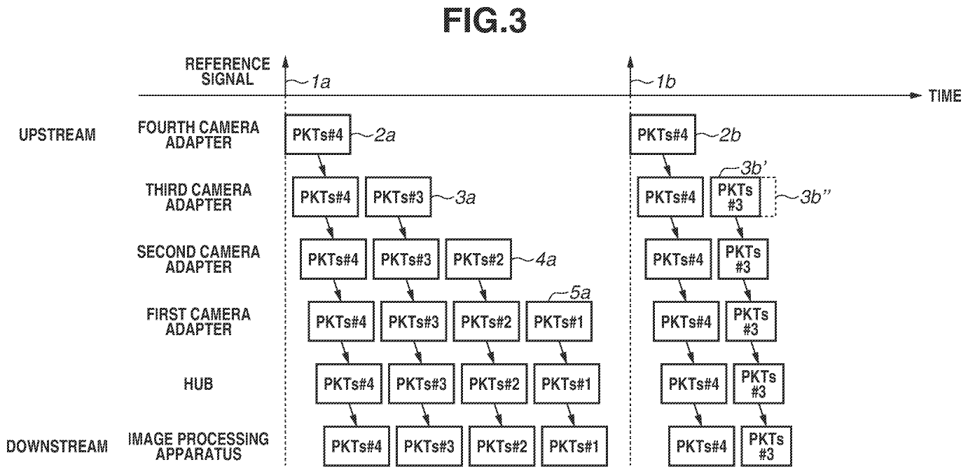

FIG. 3 is a diagram illustrating an issue in a comparative example.

In the comparative example, similarly to the synchronous imaging system 300 according to the first exemplary embodiment, the image packets 2a to 5a generated by the camera adapters 301 are transmitted in order from the fourth camera adapter 301 that is the furthest upstream to the image processing apparatus 360. FIG. 3 illustrates a case where an abnormality, such as a camera failure, occurs in the imaging unit 390 including the third camera adapter 301 while the third camera adapter 301 is transmitting the image packet 3b.

The third camera adapter 301 can transmit, as an image packet 3b′, a part of an image associated with the reference signal 1b, but cannot generate an image packet 3b″ that is the other part of the image due to an occurrence of the abnormality. The image packet 3b″ that cannot be generated includes an image packet including start instruction information. In the case of the comparative example, the camera adapter 301 cannot transmit the start instruction information downstream.

Thus, the second camera adapter 301 can transfer the image packet 2b and the image packet 3b′ received from the third camera adapter 301, but cannot generate and transmit an image packet of the second camera adapter 301. Thus, the second camera adapter 301 cannot transmit an image packet including start instruction information downstream, either, and the camera adapters 301 downstream of the second camera adapter 301 cannot generate and transmit image packets of the camera adapters 301 in a chain reaction manner, either.

In other words, in the comparative example, if an abnormality, such as a camera failure, occurs in any one of the plurality of camera adapters 301 and the one camera adapter 301 cannot generate an image packet, the other camera adapters 301 downstream of the one camera adapter 301 cannot generate and transmit image packets of the other camera adapters 301. As a result, the amount of information reaching the image processing apparatus 360 decreases, and image quality of a virtual viewpoint content generated by the image processing apparatus 360 using images associated with the reference signal 1b degrades.

In contrast to the above-described comparative example, in the synchronous imaging system 300 according to the first exemplary embodiment, image packets can be generated and transmitted even by the camera adapters 301 downstream of the one camera adapter 301 that cannot generate an image packet as described below.

### <Configuration of Camera Adapter>

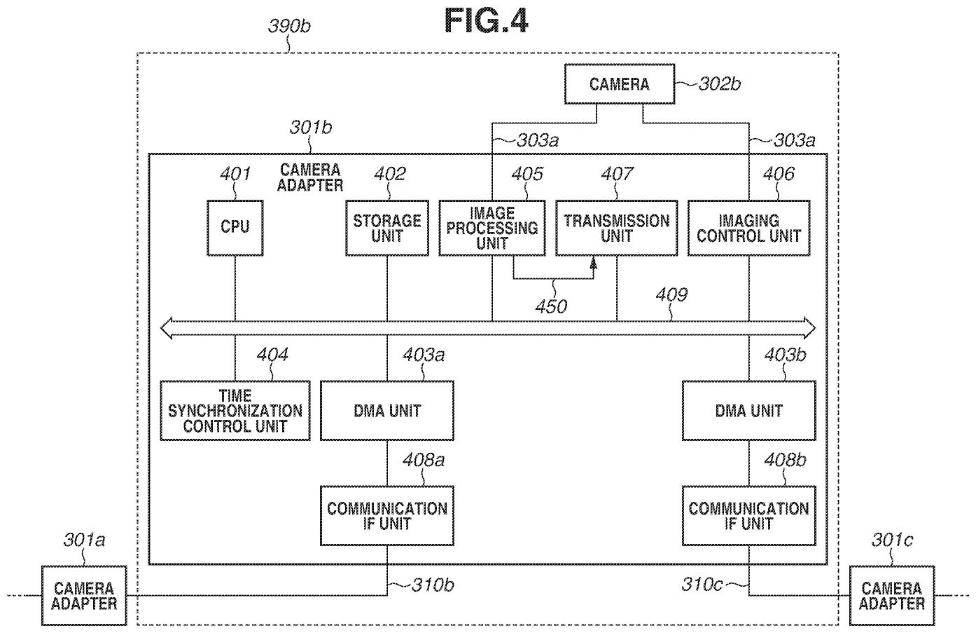

FIG. 4 is a diagram illustrating an internal configuration of a camera adapter 301 according to the first exemplary embodiment. FIG. 4 illustrates the internal configuration of the second camera adapter 301b as a typical camera adapter 301.

The camera adapter 301b includes a central processing unit (CPU) 401, a storage unit 402, direct memory access (DMA) units 403a and 403b, and a time synchronization control unit 404. Further, the camera adapter 301b includes an image processing unit 405, an imaging control unit 406, a transmission unit 407, communication interface (IF) units 408a and 408b, and a system bus 409.

The CPU 401 is a processing unit that controls the entirety of the camera adapter 301b. The CPU 401 also exchanges a synchronization packet with the time server 320 and exchanges a control packet with the control terminal 380.

The storage unit 402 is a memory that holds a program for the CPU 401 and a synchronization packet and a control packet that are transmitted and received. The storage unit 402 also holds image data generated by the image processing unit 405 performing image processing on captured data received from the camera 302. While FIG.

4 illustrates the storage unit 402 as a single block, a plurality of storage units 402 may be provided depending on the purpose. In a case where the plurality of storage units 402 is provided, the types of memories of the storage units 402 may be different from each other.

Each of the DMA units 403a and 403b performs DMA for transmitting and receiving a packet. The DMA unit 403a or 403b performs DMA according to a transfer instruction from the CPU 401 or the transmission unit 407. The transmission unit 407 gives a transfer instruction regarding an image packet, and the CPU 401 gives a transfer instruction regarding a synchronization packet.

In DMA for transmitting a packet, the DMA unit 403a or 403b reads an image packet from a specified area in the storage unit 402 and outputs the image packet to the corresponding communication IF unit 408a or 408b. In DMA for receiving a packet, the DMA unit 403a or 403b transfers an image packet received from the corresponding communication IF unit 408a or 408b to a specified area in the storage unit 402. Each of the DMA units 403a and 403b can buffer a plurality of transfer instructions.

Each of the communication IF units 408a and 408b functions to process layers 1 and 2 of the Open Systems Interconnection (OSI) reference model and transmits and receives a communication packet to and from outside the camera adapter 301b. As the communication packet, a synchronization packet, a Transmission Control Protocol/Internet Protocol (TCP/IP) packet, and an image packet are transmitted and received.

A synchronization packet transmitted from the time server 320 is received by the communication IF unit 408a on the root side via a camera adapter 301a on the root side. Then, the synchronization packet is transferred by the DMA unit 403a on the root side to the storage unit 402 according to a transfer instruction generated by the CPU 401.

The synchronization packet is subjected to protocol processing inside the camera adapter 301b and then transmitted to a camera adapter 301c on the leaf side adjacent to the camera adapter 301b via the DMA unit 403b and the communication IF unit 408b on the leaf side according to an instruction from the CPU 401.

Similarly, a synchronization packet transmitted from each camera adapter 301 on the leaf side to the time server 320 is received via the communication IF unit 408b and the DMA unit 403b on the leaf side and transferred to the storage unit 402.

Then, the synchronization packet is subjected to the protocol processing, transferred from the storage unit 402 to the DMA unit 403a and the communication IF unit 408a on the root side according to an instruction from the CPU 401, and ultimately transmitted to the time server 320.

A synchronization packet generated by the camera adapter 301b is also similarly stored in the storage unit 402, transmitted to the camera adapter 301a on the root side via the DMA unit 403a and the communication IF unit 408a on the root side, and transmitted to the time server 320.

The transmission and reception of an image packet will be described below.

Each communication IF unit 408 includes an internal clock and has a timestamp function for holding the time of the internal clock when the communication IF unit 408 transmits or receives a synchronization packet. The CPU 401 uses the timestamp function to perform calculation for time synchronization. The timestamp function can precisely determine the transmission/reception time of a synchronization packet and the residence time of the synchronization packet in the camera adapter 301b.

To measure the precise residence time of a synchronization packet, the clocks of the communication IF units 408a and 408b synchronize the times with each other before starting time synchronization based on the PTP. A difference in time from the time server 320 determined by PTP protocol processing is applied to all the clocks in the communication IF units 408 and is controlled by the CPU 401 so that the communication IF units 408 are always synchronized with the time server 320.

The time synchronization control unit 404 includes its own clocks synchronized with the respective clocks in the communication IF units 408 and outputs a synchronization signal of 1 hertz (Hz), for example, synchronized with either of the clocks of the time synchronization control unit 404 to the imaging control unit 406. Since the two communication IF units 408 include a total of two clocks, the time synchronization control unit 404 also includes two clocks inside. The synchronization signal output from the time synchronization control unit 404 is synchronized with either of the clocks inside. Since the clocks in the communication IF units 408 are synchronized with the time server 320, the synchronization signal output from the time synchronization control unit 404 is also synchronized with the time server 320.

The imaging control unit 406 controls the camera 302b. If the camera adapter 301b receives an instruction from the control terminal 380 via the hub 340, the CPU 401 makes settings of the imaging control unit 406. Then, the imaging control unit 406 starts outputting a genlock signal and a timecode to the camera 302. The genlock signal and the timecode are generated based on the synchronization signal received from the time synchronization control unit 404.

The imaging control unit 406 also outputs a part of the timecode as a trigger signal to the image processing unit 405. The trigger signal is also synchronized with the synchronization signal. In the present exemplary embodiment, the trigger signal is generated in a period equivalent to an imaging frame rate of the camera 302b.

For example, in a case where the imaging frame rate of a camera adapter 301 for generating a foreground image is 60 frames per second (fps) and the imaging frame rate of a camera adapter 301 for generating a background image is 30 fps, the periods of trigger signals to be generated are 60 Hz and 30 Hz, respectively.

The camera 302b captures an image in synchronization with the genlock signal and outputs captured data with the received timecode to the image processing unit 405.

The image processing unit 405 performs image processing required to generate a virtual viewpoint image from the captured data received from the camera 302b and transfers image data obtained as a result of the processing to the storage unit 402. The image processing performed by the image processing unit 405 is, for example, clipping a part to be a background or a part to be a foreground.

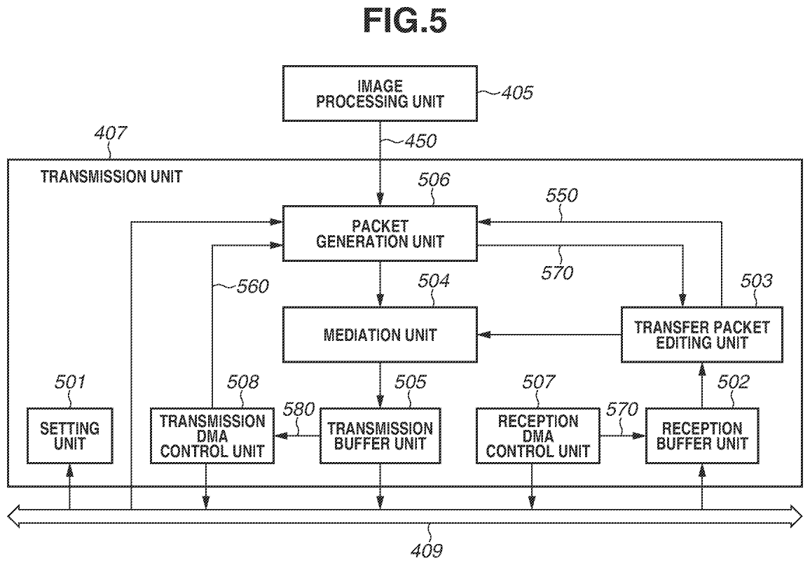

At the timing when the image processing unit 405 receives the trigger signal, the image processing unit 405 notifies the transmission unit 407 of information regarding the generated image data using a notification signal 450 (see FIG. 5). The notification signal 450 includes address information indicating a storage area in the storage unit 402 with respect to each image type, such as a foreground image or a background image, a data size, and a frame number. In the following description, these pieces of information included in the notification signal 450 are referred to as “notification information”.

Imaging processing by the camera 302 or the image processing by the image processing unit 405 requires overhead to start the processing. Thus, a notification signal 450 that gives a notification based on an N-th received trigger signal does not necessarily notify the transmission unit 407 of image data obtained by processing N-th captured data received from the camera 302. In consideration of delay due to overhead, the notification signal 450 that gives a notification based on the N-th received trigger signal may notify the transmission unit 407 of image data obtained by performing image processing on (N−1)-th or (N−2)-th captured data due to a lag by one or two pieces of captured data.

If the N-th notification signal 450 notifies the transmission unit 407 of the image data obtained by processing the (N−1)-th captured data, the lag between the notification signal 450 and the captured data does not change after that.

The transmission unit 407 packetizes the image data based on the notification information in the notification signal 450 received from the image processing unit 405, thereby generating an image packet. Then, the transmission unit 407 gives a transfer instruction to the DMA unit 403a on the root side. The transmission unit 407 receives the notification signal 450 generated based on time synchronized with that of the time server 320 in the same period as the imaging frame rate. Thus, a transfer instruction to transfer an image packet is also periodically generated.

Further, the transmission unit 407 relays an image packet received from an adjacent camera adapter 301. More specifically, using the DMA unit 403b on the leaf side, the transmission unit 407 imports an image packet transmitted from the camera adapter 301 on the leaf side. Then, the transmission unit 407 gives a transfer instruction to the DMA unit 403a on the root side, and transmits the image packet to the camera adapter 301 on the root side.

Details of the generation, transmission, and relay of an image packet by the transmission unit 407 will be described below.

### <Function of Transmission Unit>

FIG. 5 is a functional block diagram illustrating internal functions of the transmission unit 407 according to the first exemplary embodiment.

The configuration illustrated in FIG. 5 is merely an example. Alternatively, a plurality of functional blocks may be included in a single functional block, or any of the functional blocks may be divided into blocks that perform a plurality of functions. Yet alternatively, at least one of the functional blocks may be implemented as hardware. In a case where at least one of the functional blocks is implemented as hardware, for example, a predetermined compiler may be used to automatically generate a dedicated circuit on a field-programmable gate array (FPGA) according to a program for implementing steps.

Alternatively, a gate array circuit may be formed similarly to the FPGA, and at least one of the functional blocks may be implemented as hardware. Yet alternatively, at least one of the functional blocks may be implemented by an application-specific integrated circuit (ASIC).

The transmission unit 407 includes a setting unit 501, a reception buffer unit 502, a transfer packet editing unit 503, a mediation unit 504, a transmission buffer unit 505, and a packet generation unit 506. The transmission unit 407 also includes a reception DMA control unit 507 and a transmission DMA control unit 508.

The setting unit 501 includes a control information register that holds control information regarding the entire transmission unit 407.

The functional blocks of the transmission unit 407 can refer to the control information register in the setting unit 501, and operate with settings indicated by the CPU 401. The setting unit 501 includes a state holding register that holds states of the functional blocks of the transmission unit 407, and the CPU 401 can monitor the states of the functional blocks using the state holding register.

The reception buffer unit 502 has a function of receiving an image packet received by the communication IF unit 408b on the leaf side from the DMA unit 403b and temporarily holding the image packet, and a function of outputting a held image packet to the transfer packet editing unit 503. An image packet to be output from the reception buffer unit 502 is the oldest image packet among image packets accumulated in a buffer of the reception buffer unit 502. In other words, the reception buffer unit 502 outputs the image packets in order of reception. The reception buffer unit 502 starts outputting a received image packet after receiving a DMA completion notification 570 from the reception DMA control unit 507.

The reception DMA control unit 507 gives a transfer instruction for receiving an image packet to the DMA unit 403b on the leaf side. If the CPU 401 enables the transmission unit 407 via the setting unit 501, the reception DMA control unit 507 sets a plurality of transfer instructions in the corresponding DMA unit 403.

Then, every time the reception of an image packet is completed, the reception DMA control unit 507 newly sets a transfer instruction in the corresponding DMA unit 403 and maintains a state where an image packet can be received any time.

Every time the reception of a single image packet is completed, the reception DMA control unit 507 issues the DMA completion notification 570 to the reception buffer unit 502. The DMA completion notification 570 includes data size information indicating data size of the image packet transferred by DMA. The reception buffer unit 502 can determine breaks between the image packets transferred from the DMA unit 403 based on the data size information.

The transfer packet editing unit 503 receives an image packet from the reception buffer unit 502 and outputs the image packet to the mediation unit 504. In other words, the transfer packet editing unit 503 receives the image packet via the reception buffer unit 502 and the DMA unit 403.

When the transfer packet editing unit 503 outputs the image packet, and if the received image packet matches a predetermined condition, the transfer packet editing unit 503 outputs a start notification 550 to the packet generation unit 506. If the received image packet matches the condition, the transfer packet editing unit 503 rewrites the received image packet and outputs the image packet to the mediation unit 504. Details of the rewriting will be described below.

The transfer packet editing unit 503 includes an abnormality flag inside. If the transfer packet editing unit 503 is notified of an abnormal state using an abnormality notification 570 by the packet generation unit 506, the transfer packet editing unit 503 holds the abnormal state in the abnormality flag. In the following description, holding of the abnormal state in the abnormality flag is occasionally referred to as “setting the flag”, and cancellation of the holding of the abnormal state in the abnormality flag is occasionally referred to as “clearing the flag”.

The abnormality notification 570 indicates the abnormal state by ‘H’ and indicates a normal state by ‘L’. If the transfer packet editing unit 503 receives the abnormality notification 570 indicating ‘L’, the abnormality flag is cleared. In the following description, a state where the abnormality notification 570 changes to ‘H’ is occasionally referred to as “increasing the notification”, and a state where the abnormality notification 570 changes to ‘L’ is occasionally referred to as “decreasing the notification”.

The mediation unit 504 mediates image packets received from the transfer packet editing unit 503 and the packet generation unit 506 and outputs the image packets to the transmission buffer unit 505.

The transmission buffer unit 505 has a function of temporarily holding an image packet to be transmitted to another camera adapter 301. If the transmission buffer unit 505 receives an image packet from the mediation unit 504, the transmission buffer unit 505 issues a DMA start notification 580 to the transmission DMA control unit 508. The DMA start notification 580 includes data size information regarding the image packet stored in a buffer and is issued at a timing when the last data of the image packet is stored in the transmission buffer unit 505.

In a case where an image packet to which last packet information is assigned is stored in the transmission buffer unit 505, the DMA start notification 580 also includes an identifier indicating that it is the last image packet. The last packet information indicates that it is the last image packet of a packet group composed of one or more image packets transmitted as a series of image packets.

In the present exemplary embodiment, the last packet information is used as the start instruction information described above. In other words, the start instruction information is included in the last image packet of the packet group composed of one or more image packets communicated as a series of image packets.

If the transmission DMA control unit 508 receives the DMA start notification 580 from the transmission buffer unit 505, the transmission DMA control unit 508 gives a transfer instruction to transmit the image packet to the DMA unit 403a on the root side. If the transfer of the image packet in response to the DMA start notification 580 including the identifier indicating that it is the last image packet is completed in the DMA unit 403, the transmission DMA control unit 508 issues a transfer completion notification 560 to the packet generation unit 506.

The packet generation unit 506 controls generation of a packet regarding a background image or a foreground image generated by the image processing unit 405. The packet generation unit 506 acquires image data to be a payload of an image packet via the system bus 409 using the notification information included in the notification signal 450. The packet generation unit 506 generates header information and links the header information to the image data acquired via the system bus 409, thereby generating an image packet.

The packet generation unit 506 starts generating the image packet when the start notification 550 is received.

If the image data size of which the packet generation unit 506 is notified using the notification signal 450 is 0 bytes, the packet generation unit 506 transmits the abnormality notification 570 to the transfer packet editing unit 503. If the image data size is not 0 bytes, the packet generation unit 506 sets the abnormality notification 570 to ‘L’.

Alternatively, the packet generation unit 506 may include a transmission completion timer that counts the time from when transmission of an image packet generated by the packet generation unit 506 is started to when the transmission of the last image packet needs to be completed. In this case, if the transmission completion timer expires, the packet generation unit 506 notifies the transfer packet editing unit 503 of the abnormal state using the abnormality notification 570 indicating ‘H’. In the next frame, the packet generation unit 506 sets the abnormality notification 570 to ‘L’. In other words, if a predetermined time elapses after an image packet including start instruction information is received, the packet generation unit 506 determines that an image packet cannot be generated.

An internal configuration of an image packet is described.

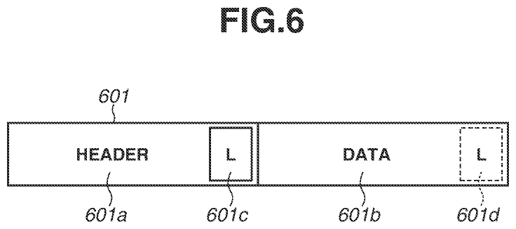

FIG. 6 is a diagram illustrating the internal configuration of an image packet 601.

The image packet 601 includes a header 601a and data 601b.

The header 601a includes a frame number, a camera adapter ID, an image type, an image payload size, an image offset, last data information, and last packet information 601c, separately from an Ethernet® header based on Ethernet®.

The frame number indicates the number of frames in a moving image. For example, if the frame rate is 60 fps, the frame number has a value from 0 to 59. If a single image packet 601 cannot store all image data for a single frame, the same frame number is assigned to a plurality of image packets 601. The frame number included in the notification signal 450 described above is used as the header 601a of the image packet 601.

The camera adapter ID indicates a camera adapter 301 having generated the image packet 601 and has a value unique to each camera adapter 301.

The image type indicates the type of image, such as a foreground image or a background image, clipped by performing image processing on captured data.

The image payload size indicates the data length of image data included in the image packet 601.

The image offset indicates the offset amount from the beginning of the image data. If the offset is zero, it indicates that it is first data of the image data. If a single image packet 601 cannot store image data for one frame, the image data is divided into a plurality of image packets 601, and offset information is described as position information regarding positions of the divided image data.

In a case where the packet generation unit 506 generates a plurality of image packets 601 by dividing image data, the packet generation unit 506 divides the image data in order from the beginning of the image data. The image processing apparatus 360 loads the image data onto a memory inside the image processing apparatus 360 and reconstructs (reassembles) the image data using image offsets of image packets 601.

The last data information indicates that the image packet is the last image packet 601 with respect to each image type in a frame number N (N is 0 or a positive integer). If the value of the last data information is “1”, the image packet 601 is the last image packet 601. If the value is “0”, it means that the last data information is erased.

The last packet information 601c indicates that the image packet is the last image packet 601 in the frame number N. If the value of the last packet information 601c is “1”, the image packet 601 is the last image packet 601. If the value is “0”, it means that the last packet information 601c is erased.

More specifically, the last packet information 601c handled as start instruction information is included in the header 601a of the last image packet 601.

For example, in a case where two types of image data, namely a foreground image and a background image, are present and a camera adapter 301 is notified of N as the frame number, the camera adapter 301 transmits two image packets 601 including the last data information having the value “1” and the frame number N. In this case, the camera adapter 301 also transmits one image packet 601 including the last packet information 601c having the value “1” and the frame number N.

Alternatively, the image packet 601 may include last packet information 601d at the end of the data 601b instead of the last packet information 601c in the header 601a. More specifically, the last packet information 601c handled as the start instruction information may be included at the end of the last image packet 601.

### <Transmission of Image Packet>

With reference to FIGS. 4 and 5, a description is given below of processing in a case where a camera adapter 301 transmits an image packet to an adjacent camera adapter 301. First, a description is given of processing in a case where the camera adapter 301 transmits (transfers) a received image packet to the adjacent camera adapter 301.

The communication IF unit 408b on the leaf side receives an image packet transmitted from the camera adapter 301c adjacent on the leaf side to the camera adapter 301b via the network cable 310c. The communication IF unit 408b on the leaf side performs a data conversion process on the received image packet and then outputs the image packet to the DMA unit 403b. The DMA unit 403b receives a transfer instruction given by the reception DMA control unit 507 and transfers the received image packet to the reception buffer unit 502. If the transfer of the image packet is completed, the reception DMA control unit 507 outputs the DMA completion notification 570 to the reception buffer unit 502.

Based on the data size information included in the received DMA completion notification 570, the reception buffer unit 502 outputs an image packet corresponding to a single packet to the transfer packet editing unit 503. The transfer packet editing unit 503 outputs the received image packet to the mediation unit 504.

When the transfer packet editing unit 503 outputs the image packet, the transfer packet editing unit 503 analyzes the header 601a of the image packet. If the image packet includes the last packet information 601c (i.e., the last packet information 601c has the value “1”), the transfer packet editing unit 503 rewrites the header 601a and issues the start notification 550. When the transfer packet editing unit 503 rewrites the header 601a, for example, the transfer packet editing unit 503 rewrites the last packet information 601c with the value “0”, thereby substantially deleting the last packet information 601c.

The mediation unit 504 outputs the image packet received from the transfer packet editing unit 503 to the transmission buffer unit 505. The transmission buffer unit 505 holds the received image packet inside and notifies the transmission DMA control unit 508 that DMA can be started, using the DMA start notification 580.

The DMA start notification 580 also includes information regarding the packet length of the image packet.

The transmission DMA control unit 508 having received the DMA start notification 580 gives a transfer instruction to the DMA unit 403a. The DMA unit 403a having received the transfer instruction reads the image packet in the transmission buffer unit 505 based on address information and data size information included in the transfer instruction and outputs the image packet to the communication IF unit 408a. The communication IF unit 408a converts the received image packet into information that can be transmitted to the network cable 310, and transmits the information to the adjacent camera adapter 301a.

Next, a description is given of the transmission of an image packet internally generated by the camera adapter 301.

As described above, if the packet generation unit 506 receives the start notification 550 from the transfer packet editing unit 503, the packet generation unit 506 starts generating an image packet. If, however, another camera adapter 301 is not connected on the leaf side to the camera adapter 301, the packet generation unit 506 starts generating an image packet based on a timeout of a transmission start timer.

The packet generation unit 506 assigns the last packet information 601c to (i.e., sets the value “1” in) the last generated image packet. The image packet generated by the packet generation unit 506 is output to the mediation unit 504.

The mediation unit 504 outputs the image packet received from the packet generation unit 506 to the transmission buffer unit 505. Then, similarly to the transmission of the received image packet, the image packet is transmitted to the adjacent camera adapter 301.

The above processing performed by the transfer packet editing unit 503 and the packet generation unit 506 is continued until the camera adapter 301 finishes transmitting image data of which the transfer packet editing unit 503 and the packet generation unit 506 are notified using the notification signal 450, as image packets. Since the last transmitted image packet includes the last packet information 601c (the last packet information 601c has the value “1”), the received image packet and the generated image packet as a series of image packets are transmitted as a packet group.

More specifically, in the present exemplary embodiment, the start instruction information is included in the last image packet in a packet group composed of one or more image packets communicated as a series of image packets. Further, in the present exemplary embodiment, the start instruction information is the last packet information indicating that an image packet including the start instruction information is the last image packet.

As a result of the above processing performed by the transfer packet editing unit 503 and the packet generation unit 506, if the received image packet includes the start instruction information, the received image packet from which the start instruction information is deleted and the generated image packet including the start instruction information are transmitted.

Next, with reference to a flowchart, a description is given of operations of transferring, generating, and transmitting an image packet performed by the transmission unit 407.

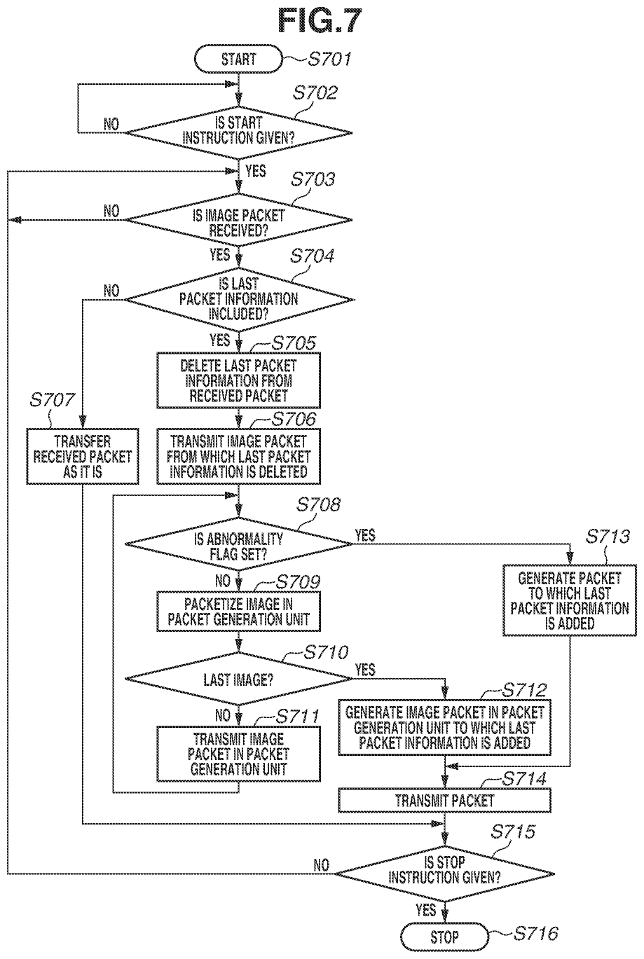

FIG. 7 is a flowchart illustrating the operations of transferring, generating, and transmitting an image packet performed by the transmission unit 407.

The processing operation illustrated in FIG. 7 mainly includes waiting for reception of an image packet (step S703), transfer of the received packet (steps S704 to S707), and transmission of an image packet (steps S708 to S714).

In step S701, the processing operation illustrated in FIG. 7 is started when any of the camera adapters 301 is powered on and started up as one of the terminals included in the synchronous imaging system 300 illustrated in FIG. 1, and a driver of the transmission unit 407 is loaded for the CPU 401.

First, in step S702, the camera adapter 301 is in a waiting state (NO in step S702) until the camera adapter 301 is instructed to start generating and transferring an image packet 601 by the control terminal 380. If the camera adapter 301 is instructed to start generating and transferring an image packet 601 (YES in step S702), the processing proceeds to step S703.

In step S703, the camera adapter 301 is in a waiting state (NO in step S703) until the transfer packet editing unit 503 receives an image packet 601 from the reception buffer unit 502. If an image packet 601 is received (YES in step S703), the processing proceeds to step S704. In step S704, it is determined whether the last packet information 601c is included in the received image packet 601.

If the last packet information 601c is not included in the image packet 601 (NO in step S704), the processing proceeds to step S707. In step S707, the transfer packet editing unit 503 outputs the image packet 601 received from the reception buffer unit 502 as it is to the mediation unit 504 without editing the image packet 601.

Then, in step S715, it is determined whether the transmission unit 407 has received an instruction to stop the processing from the CPU 401. If the instruction to stop the processing is received (YES in step S715), then in step S716, the processing ends. If the instruction to stop the processing is not received (NO in step S715), the processing returns to step S703.

If the last packet information 601c is included in the image packet 601 in step S704 (YES in step S704), the processing proceeds to step S705. In step S705, the transfer packet editing unit 503 deletes the last packet information 601c from the image packet 601 received from the reception buffer unit 502. Specifically, deletion of the last packet information 601c is executed by rewriting the value of the last packet information 601c with “0”. Then, in step S706, the transfer packet editing unit 503 outputs the image packet 601 from which the last packet information 601c is deleted to the mediation unit 504.

Then, in step S708, it is determined whether the abnormality flag inside the transfer packet editing unit 503 is set.

If the abnormality flag is not set (NO in step S708), the processing proceeds to step S709. In step S709, the packet generation unit 506 packetizes an image generated by the image processing unit 405. Then, in step S710, it is determined whether the image packetized by the packet generation unit 506 is the last image held in the packet generation unit 506 (i.e., the last image packet).

If the packetized image is not the last image (NO in step S710), the processing proceeds to step S711. In step S711, the packet generation unit 506 outputs the image packet 601 to the mediation unit 504. As a result, the mediation unit 504 outputs the image packet 601 to the transmission buffer unit 505, and the image packet 601 is transmitted to the adjacent camera adapter 301 via the DMA unit 403a and the communication IF unit 408a. Then, the processing returns to step S708.

If the packetized image is the last image held in the packet generation unit 506 in step S710 (YES in step S710), the processing proceeds to step S712. In step S712, the packet generation unit 506 adds the last packet information 601c to the image packet 601. Specifically, the addition of the last packet information 601c is executed by rewriting the value of the last packet information 601c with “1”.

Then, in step S714, the packet generation unit 506 outputs the image packet 601 including the last packet information 601c to the mediation unit 504. As a result, the mediation unit 504 outputs the image packet 601 to the transmission buffer unit 505, and the image packet 601 is transmitted to the adjacent camera adapter 301 via the DMA unit 403a and the communication IF unit 408a. Then, the processing proceeds to step S715, and processing similar to that described above is performed.

If the abnormality flag inside the transfer packet editing unit 503 is set in step S708 (YES in step S708), then in step S713, the transfer packet editing unit 503 generates a communication packet including the last packet information 601c. Then, in step S714, the transfer packet editing unit 503 outputs the communication packet including the last packet information 601c to the mediation unit 504. Then, processing similar to that described above is performed.

The communication packet generated in step S713 does not have to include image data other than the header 601a. This is because a part of image data of an image captured by the imaging unit 390 cannot be recovered due to the occurrence of a failure in the packet generation unit 506, and even if the image processing apparatus 360 reassembles the image data, the image processing apparatus 360 cannot recover the image data to the original image before the image data is fragmented.

Thus, for example, the above-described communication packet is transmitted in a minimum necessary data size so that a band of a transmission path is not wasted and the last packet information 601c is transmitted to the downstream camera adapter 301 in the shortest time. The minimum necessary data size depends on a standard used by the communication IF unit 408 and is 64 bytes in the case of Ethernet. Of the 64 bytes, 4 bytes of a frame check sequence may be generated by the communication IF unit 408.

More specifically, if an image packet cannot be generated, a communication packet including at least the start instruction information is transmitted. In the present exemplary embodiment, as the communication packet, a packet that includes the start instruction information and does not include image data is transmitted. Further, as the communication packet including at least the start instruction information, a packet of the minimum size including the start instruction information is transmitted.

The communication packet generated in step S713 is not limited to the above-described packet, and for example, may be an image packet including the start instruction information and data of a dummy image. Inclusion of the data of the dummy image reduces a difference between transmission timings in the abnormal state and the normal state. Thus, an unintended failure due to the difference between the transmission timings is avoided.

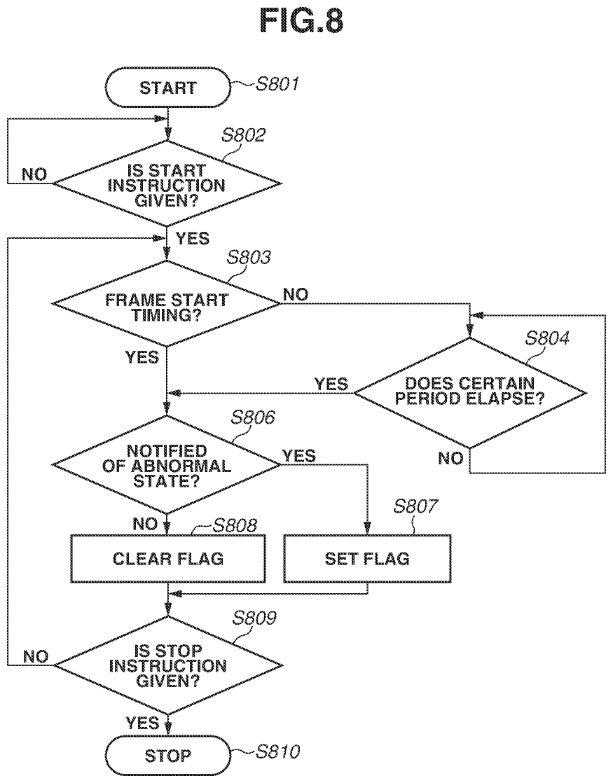

FIG. 8 is a flowchart illustrating a process of setting the abnormality flag.

In step S801, the processing illustrated in FIG. 8 is started when any of the camera adapters 301 is powered on and started up as one of the terminals included in the synchronous imaging system 300 illustrated in FIG. 1, and the driver of the transmission unit 407 is loaded for the CPU 401.

First, in step S802, the camera adapter 301 is in a waiting state (NO in step S802) until the camera adapter 301 is instructed to start generating and transferring an image packet 601 by the control terminal 380. If the camera adapter 301 is instructed to start generating and transferring an image packet 601 (YES in step S802), the processing proceeds to step S803.

In step S803, the CPU 401 determines whether it is a first reception timing (i.e., a frame start timing) of the first notification signal 450 in an N-th frame. Then, if it is not the frame start timing (NO in step S803), the processing proceeds to step S804. In step S804, the camera adapter 301 is in a waiting state (NO in step S804) until a certain period elapses. If the certain period elapses (YES in step S804), the processing proceeds to step S806. If it is the frame start timing in step S803 (YES in step S803), step S804 is skipped, and the processing proceeds to step S806.

In step S806, it is determined whether the transfer packet editing unit 503 is notified of the abnormal state using the abnormality notification 570 by the packet generation unit 506. If the transfer packet editing unit 503 is notified of the abnormal state (YES in step S806), the processing proceeds to step S807. In step S807, the transfer packet editing unit 503 sets the value “1” in the abnormality flag. If, on the other hand, the transfer packet editing unit 503 is not notified of the abnormal state (NO in step S806), the processing proceeds to step S808. In step S808, the transfer packet editing unit 503 clears the abnormality flag.

By the transfer packet editing unit 503 setting the abnormality flag, the processing illustrated in FIG. 7 proceeds from step S708 to step S713. The packetization of an image is skipped, and the last packet information 601c is transmitted to the downstream camera adapter 301.

The abnormal state corresponds to, for example, a case where the size of the image of which the camera adapter 301 is notified using the notification signal 450 is 0 bytes, or a case where the transmission completion timer expires.

Regarding the case where the transmission completion timer expires, the transfer packet editing unit 503 may determine the abnormal state without depending on the abnormality notification 570 and set the abnormality flag. In this case, the abnormality flag is cleared at the next frame start timing.

After steps S807 and S808, the processing proceeds to step S809. In step S809, it is determined whether the camera adapter 301 receives an instruction to stop the processing of transferring and transmitting a packet from the control terminal 380. If the instruction to stop the processing is received (YES in step S809), then in step S810, the processing ends. If the instruction to stop the processing is not received (NO in step S809), the processing returns to step S803.

As a result of the processing illustrated in FIGS. 7 and 8, the received image packet 601 is transmitted to the adjacent camera adapter 301, and the image packet 601 including the last packet information 601c is transmitted after the last packet information 601c is deleted.

Then, if the packet generation unit 506 is in the normal state, the packet generation unit 506 packetizes an image by receiving the image packet 601 including the last packet information 601c. Then, the obtained image packet 601 is transmitted to the adjacent camera adapter 301, and the last packet information 601c is added to the last image packet 601.

If, on the other hand, the packet generation unit 506 is in the abnormal state and an image packet cannot be generated, the abnormality flag is set, and a communication packet including the last packet information 601c is generated by the transfer packet editing unit 503 and transmitted to the adjacent camera adapter 301.

More specifically, even if the packet generation unit 506 is in the abnormal state, the last packet information 601c is transmitted to the downstream camera adapter 301. Thus, the camera adapters 301 present downstream of the camera adapter 301 including the packet generation unit 506 can transmit generated image data as an image packet.

Next, another exemplary embodiment of the present disclosure is described. The following description is given focusing on differences from the first exemplary embodiment. Components similar to those in the first exemplary embodiment are designated by the same numerals, and are not redundantly described.

A second exemplary embodiment of the present disclosure is an exemplary embodiment similar to the first exemplary embodiment except for a part of the processing illustrated in FIG. 7.

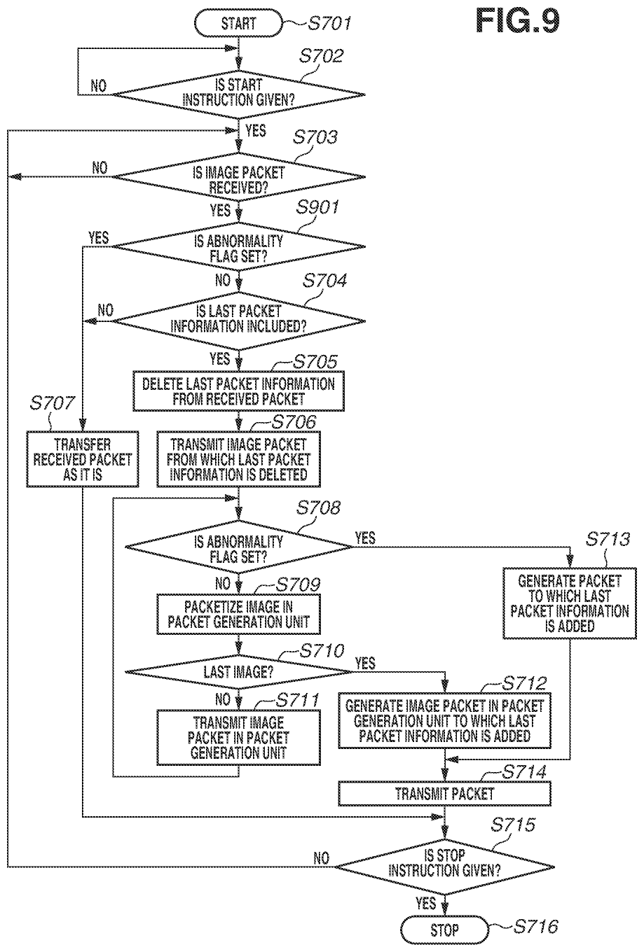

FIG. 9 is a flowchart illustrating the operations of transferring, generating, and transmitting an image packet according to the second exemplary embodiment.

In the processing illustrated in FIG. 9, if an image packet 601 is received in step S703 (YES in step S703), then in step S901 before step S704, it is determined whether the abnormality flag is set. Then, if the abnormality flag is not set (NO in step S901), similarly to the first exemplary embodiment, the processing proceeds to step S704. If, on the other hand, the abnormality flag is set in step S901 (YES in step S901), the processing proceeds to step S707. In step S707, the received image packet 601 is transferred as it is to the adjacent camera adapter 301.

More specifically, in the second exemplary embodiment, if the abnormality flag in the transfer packet editing unit 503 is set at a timing when the received image packet 601 is transferred, the received image packet 601 including the last packet information 601c is also transferred as it is, and an image packet 601 is not generated by the transfer packet editing unit 503.

In other words, in the second exemplary embodiment, if an image packet cannot be generated, a received image packet including the start instruction information is transmitted as the communication packet in the state where the start instruction information remains undeleted.

In the first exemplary embodiment, even in the abnormal state, the last packet information 601c is deleted from the received image packet 601, and then, a communication packet including the last packet information 601c is generated by and transmitted from the transfer packet editing unit 503. In contrast, in the second exemplary embodiment, duplicated efforts of the deletion and the generation are avoided. Particularly, in the second exemplary embodiment, if the state where an image packet cannot be generated is not temporary but continuous for a certain amount of time, the image packet 601 continues to be exclusively transferred due to branching in step S901, and thus the load of the transmission unit 407 is reduced.

Also in the second exemplary embodiment, if the packet generation unit 506 enters the abnormal state while the packet generation unit 506 generates an image packet, then in step S713, the transfer packet editing unit 503 generates a communication packet including the last packet information 601c.

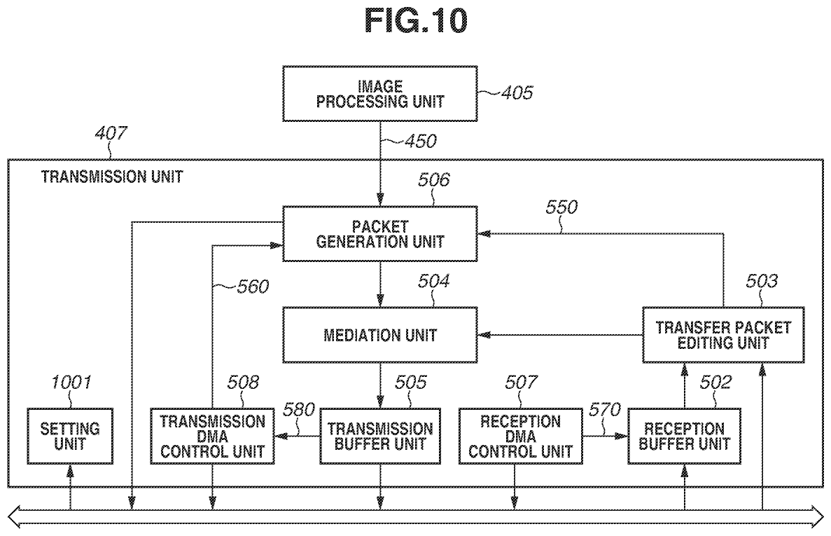

FIG. 10 is a functional block diagram illustrating internal functions of the transmission unit 407 according to a third exemplary embodiment.

In the transmission unit 407 according to the third exemplary embodiment, an abnormality flag is included in a setting unit 1001. If the CPU 401 detects an abnormality in the packet generation unit 506, the CPU 401 sets the abnormality flag in the setting unit 1001. The CPU 401 also gives an instruction to clear the abnormality flag.

The setting unit 1001 includes control information registers that hold control information regarding the entire transmission unit 407. The functional blocks of the transmission unit 407 can refer to the control information registers in the setting unit 1001. The CPU 401 controls the functional blocks using the control information registers. In the third exemplary embodiment, the abnormality flag is included as one of the control information registers.

The setting unit 1001 also includes state holding registers that hold states of the functional blocks of the transmission unit 407. The CPU 401 can monitor the states of the functional blocks using the state holding registers. In the third exemplary embodiment, a data abnormality notification register is included as one of the state holding registers.

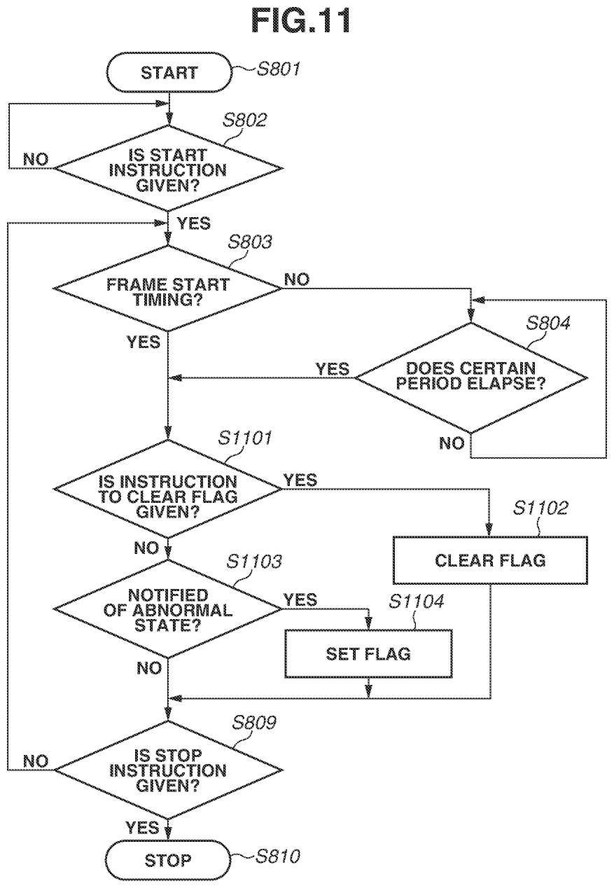

FIG. 11 is a flowchart illustrating a process of setting the abnormality flag according to the third exemplary embodiment.

In the third exemplary embodiment, after steps S803 and S804, the processing proceeds to step S1101. In step S1101, it is determined whether an instruction to clear the flag is given by the CPU 401. A condition under which the instruction to clear the flag is given corresponds to a case where information is not written in the data abnormality notification register, or a case where an instruction is received from software that controls the camera adapter 301.

If the instruction to clear the flag is given in step S1101 (YES in step S1101), the processing proceeds to step S1102. In step S1102, the abnormality flag is cleared. Then, the processing proceeds to step S809. If, on the other hand, the instruction to clear the flag is not given in step S1101 (NO in step S1101), the processing proceeds to step S1103. In step S1103, it is determined whether the CPU 401 has detected the abnormality.

A condition under which the CPU 401 detects the abnormality corresponds to, for example, a case where a value is written in the data abnormality notification register, or a case where an instruction from the software is received. Then, if the CPU 401 detects the abnormality (YES in step S1103), the processing proceeds to step S1104. In step S1104, the abnormality flag is set. If the CPU 401 does not detect the abnormality (NO in step S1103), step S1104 is skipped.

In other words, in the first exemplary embodiment, the determination of the abnormal state and the clearing of the abnormality flag are executed in the transmission unit 407 by the transfer packet editing unit 503, whereas, in the third exemplary embodiment, the determination of the abnormal state and the clearing of the abnormality flag are executed by the CPU 401. Thus, the load of the transfer packet editing unit 503 is reduced, and the CPU 401 is in charge of monitoring and control.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-026412, filed Feb. 22, 2023, which is hereby incorporated by reference herein in its entirety.

What is claimed is:

1. A communication apparatus comprising:
a reception unit configured to receive a first image packet;
a generation unit configured to generate a second image packet;
a transmission unit configured to, in a case where predetermined information is included in the first image packet, transmit the first image packet from which the predetermined information is deleted and the second image packet including the predetermined information; and
a control unit configured to, in a case where the second image packet cannot be generated, cause the transmission unit to transmit a communication packet including at least the predetermined information.

2. The communication apparatus according to claim 1, wherein the predetermined information is included in a last image packet of a packet group composed of one or more image packets communicated as a series of image packets.

3. The communication apparatus according to claim 2, wherein the predetermined information is last packet information indicating that an image packet including the predetermined information is the last image packet.

4. The communication apparatus according to claim 2, wherein the predetermined information is included in a header of the last image packet.

5. The communication apparatus according to claim 2, wherein the predetermined information is included at an end of the last image packet.

6. The communication apparatus according to claim 1, wherein, in a case where the second image packet cannot be generated, the control unit causes the transmission unit to transmit the first image packet including the predetermined information as the communication packet in a state where the predetermined information remains undeleted.

7. The communication apparatus according to claim 1, wherein, in a case where the second image packet cannot be generated, the control unit generates the communication packet and causes the transmission unit to transmit the communication packet.

8. The communication apparatus according to claim 7, wherein the control unit causes the transmission unit to transmit a packet that includes the predetermined information and does not include image data as the communication packet.

9. The communication apparatus according to claim 7, wherein the control unit causes the transmission unit to transmit a packet of a minimum size including the predetermined information as the communication packet.

10. The communication apparatus according to claim 7, wherein the control unit causes the transmission unit to transmit an image packet including the predetermined information and data of a dummy image as the communication packet.

11. The communication apparatus according to claim 1, wherein, in a case where a predetermined time elapses after the first image packet including the predetermined information is received, the control unit determines that the second image packet cannot be generated.

12. A communication system, wherein the communication apparatus according to claim 1 is connected in a daisy chain.

13. A communication method comprising:
receiving a first image packet;
generating a second image packet;
in a case where predetermined information is included in the first image packet, transmitting the first image packet from which the predetermined information is deleted and the second image packet including the predetermined information; and
in a case where the second image packet cannot be generated, transmitting a communication packet including at least the predetermined information.

14. A non-transitory storage medium storing a program causing a communication apparatus to execute a communication method, the communication method comprising:
receiving a first image packet;
generating a second image packet;
in a case where predetermined information is included in the first image packet, transmitting the first image packet from which the predetermined information is deleted and the second image packet including the predetermined information; and
in a case where the second image packet cannot be generated, transmitting a communication packet including at least the predetermined information.
